(19) United States
(12) Patent Application Publication
(10) Pub. No.: US 2020/0086946 A1
(43) Pub. Date: Mar. 19, 2020

(54) CRANK-PEDAL MECHANISM FOR BICYCLE

(71) Applicant: ROYALBABY CYCLE BEIJING CO., LTD., Beijing (CN)

(72) Inventor: Tony TONG, Beijing (CN)

(73) Assignee: ROYALBABY CYCLE BEIJING CO., LTD., Beijing (CN)

(21) Appl. No.: 16/687,711

(22) Filed: Nov. 19, 2019

Related U.S. Application Data
(63) Continuation of application No. 15/518,752, filed on Apr. 12, 2017.

(30) Foreign Application Priority Data
Feb. 5, 2015 (CN) 201510058349.5

(51) Int. Cl. B62M 3/16; B62M 3/08; B62M 3/00

(52) U.S. Cl. CPC B62M 3/16; B62K 2015/001; B62M 3/003; B62M 3/08

(57) ABSTRACT

A quick-mount crank-pedal mechanism for a children bicycle is provided. The quick-mount crank-pedal mechanism is composed of a crank rod, a crank bearing and a pedal. The crank rod and the crank bearing are fitted with each other, and the pedal is coupled to the crank bearing. With the mechanism, the pedal is enabled to be in a usable state quickly without using any tools, and a tip of the crank is effectively protected from puncturing through a carton, thereby reducing potential safety hazards.

### CROSS-REFERENCE TO RELATED APPLICATIONS

This is a continuation application of and claims the priority benefit of a prior application Ser. No. 15/518,752 filed on Apr. 12, 2017, now pending. The prior application Ser. No. 15/518,752 is a 371 of international application of PCT International Application No. PCT/CN2015/077661 filed on Apr. 28, 2015, which claims the priority benefit of China application serial no. 201510058349.5, filed on Feb. 5, 2015. The entirety of the above-mentioned patent applications are hereby incorporated by reference herein and made a part of this specification.

### TECHNICAL FIELD

The present disclosure relates to a quick-mount crank-pedal mechanism for a children bicycle.

### BACKGROUND

Since a split design is used in the existing art, link structures are relatively complex and need lots of operation procedures. Moreover, a tip of a crank is easy to pierce a carton during transportation. Therefore, a pedal mechanism in the existing art has poor firmness, is easily broken, and has potential safety hazards, and the installation thereof is troublesome.

### SUMMARY

In view of the shortcomings in the above-mentioned problems, the present disclosure provides a quick-mount crank-pedal mechanism for a children bicycle.

In order to achieve the above object, the present disclosure provides a quick-mount crank-pedal mechanism for a children bicycle. The quick-mount crank-pedal mechanism is composed of a crank rod, a crank bearing and a pedal. The crank rod is configured to be fitted with the crank bearing, and the pedal is coupled to the crank bearing. A spring protrusion is provided at a tip of the crank rod, and a clamping slot is provided on the crank bearing. The tip of the crank rod and the crank bearing are coaxially aligned with a common axis, and the pedal is rotatable around the common axis.

Further, the spring protrusion and the clamping slot are fitted with each other.

Further, a thread mechanism is provided on the crank rod, and a nut mechanism is provided in the crank bearing.

The present disclosure has the following beneficial effects: with the present mechanism, the pedal is enabled to be in a usable state quickly without using any tools, thus a customer is free from trouble in installation; the tip of the crank is effectively protected from puncturing through a carton during transportation, thereby reducing potential safety hazards. The present mechanism has many advantages such as eliminating all complicated procedures and misleading, making the consumer free from confusions, and being firmer.

### BRIEF DESCRIPTION OF DRAWINGS

FIG. 1 is an overall schematic diagram showing a quick-mount crank-pedal mechanism for a children bicycle according to the present disclosure;

FIG. 2 is a separated schematic diagram showing a quick-mount crank-pedal mechanism for a children bicycle according to the present disclosure;

List of Reference numerals: 1 crank rod; 2 crank bearing; 3 protrusion; 4 clamping slot; 5 pedal; 6 spindle.

### DETAILED DESCRIPTION

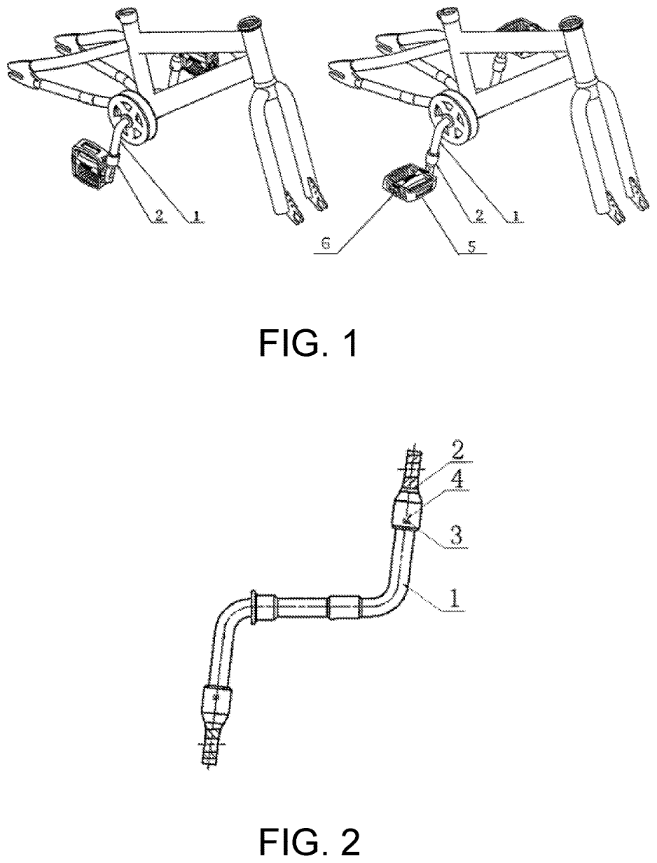

As shown in FIGS. 1 and 2, the present disclosure relates to a quick-mount crank-pedal mechanism for a children bicycle. The quick-mount crank-pedal mechanism is composed of the following parts: a crank rod 1 and a crank bearing 2. The crank rod 1 and the crank bearing 2 are fitted with each other. A tip of the crank rod 1 is provided with a spring protrusion 3 which is fitted with a clamping slot 4 provided on the crank bearing 2. The tip of the crank rod 1 and the crank bearing 2 are coaxially aligned with a common axis, and the crank bearing 2 encircles the tip of the crank rod 1. The crank-pedal mechanism further has a pedal 5. The pedal 5 is coupled to the crank bearing 2, and is rotatable around the common axis. The pedal 5 has a spindle 6. The spindle 6 is detachably coupled to the crank bearing 2, and is disposed perpendicularly to the common axis.

Through the present mechanism, the pedal is enabled to be in a usable state quickly without using any tools, thus a customer is free from trouble in installation. Moreover, the tip of the crank is effectively protected from puncturing through a carton, thereby reducing potential safety hazards. The present mechanism has advantages, such as eliminating all complicated procedures and misleading, making the consumers free from confusions, and the present mechanism is firmer.

In specific use, it is only required to rotate the pedal 5 around the common axis by 90 degrees counterclockwise so as to clamp the spring protrusion 3 provided at the tip of the crank rod 1 into the clamping slot 4 provided on the crank bearing 2, thereby preventing the crank bearing 2 from rotating and achieving a state in which the cranking bearing 2 is locked. Therefore, it is convenient to use and easy to manipulate, and a regulation effect is good.

The aforementioned is only preferred embodiments of the present disclosure. Those skilled in the art are naturally able to make equivalent changes and modifications which fall in the scope of the present disclosure, after understanding the technical means of the present disclosure according to actual needs and based on the scope of the claims of the present disclosure.

What is claimed is:

1. A crank-pedal mechanism for a bicycle, comprising:
a crank rod;
a crank bearing;
a spring protrusion, provided at a tip of the crank rod;
a clamping slot, provided on the crank bearing; and
a pedal, coupled to the crank bearing,
wherein the tip of the crank rod and the crank bearing are coaxially aligned with a common axis, and the pedal is rotatable around the common axis.

2. The crank-pedal mechanism according to claim 1, wherein the spring protrusion is clamped into the clamping slot by rotating the pedal around the common axis by 90 degrees counterclockwise.

3. The crank-pedal mechanism according to claim 1, wherein the crank bearing encircles the tip of the crank rod.

4. The crank-pedal mechanism according to claim 1, wherein a spindle of the pedal is detachably coupled to the crank bearing, and the spindle of the pedal is disposed perpendicularly to the common axis.
